(19) United States
(12) Patent Application Publication
(10) Pub. No.: US 2015/0278353 A1
(43) Pub. Date: Oct. 1, 2015

(54) METHODS AND SYSTEMS FOR SURFACING CONTENT ITEMS BASED ON IMPRESSION DISCOUNTING

(71) Applicant: Linkedln Corporation, Mountain View, CA (US)

(72) Inventors: Samir M. Shah, San Francisco, CA (US); Mitul Tiwari, Mountain View, CA (US); Pei Li, Mountain View, CA (US)

(21) Appl. No.: 14/231,233

(22) Filed: Mar. 31, 2014

(51) Int. Cl. G06F 17/30

(52) U.S. Cl. CPC G06F 17/30861

(57) ABSTRACT

Systems and methods for surfacing content items to a user based on an impression discount are described. For example, an impression discount for a content item is determined. The impression discount may be determined based on a number of times the content item has been surfaced to a user. A selection score for the content item is updated based on the impression discount. The content item is selected from a plurality of content items based on a comparison of the selection score for the content item and selection scores for each of the plurality of content items. The selected content item is then surfaced to a client device corresponding to the user.

### TECHNICAL FIELD

The present disclosure generally relates to information retrieval and processing. More specifically, the present disclosure relates to methods, systems and computer program products for surfacing content to users of a content publisher system based on impression discounts.

### BACKGROUND

Online social network services provide members with a mechanism for defining, and memorializing in a digital format, representations of themselves (e.g., member profiles) and their relationships with other people. This digital representation of relationships between members is frequently referred to as a social graph. Many social network services utilize a social graph to facilitate electronic communications and the sharing of information between its users or members. For instance, the relationship between two members of a social network service, as defined in the social graph of the social network service, may determine the access and sharing privileges that exist between the two members. As such, the social graph in use by a social network service may determine the manner in which two members of the social network service can interact with one another via the various communication and sharing mechanisms supported by the social network service.

Some social network services aim to enable friends and family to communicate and share with one another, while others are specifically directed to business users with a goal of facilitating the establishment of professional networks and the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

With many social network services, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many social network services in use today, the personal information that is commonly requested and displayed as part of a member's profile includes a member's age (e.g., birth date), gender, contact information, home town, address, the name of the member's spouse and/or family members, a photograph of the member, interests, and so forth. With certain social network services, such as some business network services, a member's personal information may include information commonly included in a professional resume or curriculum vitae, such as information about a person's education, employment history, job skills, professional organizations, and so forth.

Some traditional social network services may behave as a searchable directory of people. In such systems, a user interface (“UI”) may be provided to a member to allow that member to search for other members of the social network to connect. For example, the member may use the UI to enter key terms or other properties in which to search a population of member profiles. Based on the search result, the member may search through the member profiles matching the search criteria to identify member profiles that are of interest. Thus, traditional systems may rely on knowledge and actions from the searching member to identify member profiles that are of interest.

### DESCRIPTION OF THE DRAWINGS

Some embodiments of the technology are illustrated by way of example and not limitation in the figures of the accompanying drawings.

FIG. 1 is a block diagram illustrating various components or functional modules of a content publishing service, consistent with some embodiments, according to an example embodiment.

FIG. 2 is a data diagram illustrating an example of a data structure that includes a user identifier field that corresponds or otherwise maps to one or more content item fields, according to an example embodiment.

FIG. 3 is a flow diagram illustrating an example method for selecting and surfacing content items based on an impression discount, consistent with some embodiments.

FIG. 4 is a user interface diagram illustrating a user interface that the surfacing engine may surface to a client device of a user, according to an example embodiment.

FIG. 5 is a user interface diagram illustrating another user interface that the surfacing engine may surface to a client device of a user, according to an example embodiment.

FIG. 6 is a block diagram of a machine in the form of a computing device within which a set of instructions, for causing the machine to perform any one or more of the methodologies discussed herein, may be executed.

### DETAILED DESCRIPTION

### Overview

The present disclosure describes, among other things, methods, systems, and computer program products, which individually provide functionality for surfacing content items to users of a content publishing system using impression discounting. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Example embodiments may include systems and methods to surface content items to a user of a content publishing system based on impression discounts to those content items. By way of example and not limitation, the content items may be connection recommendations surfaced by a social networking service. Such connection recommendations may be a recommendation that attempts to solve a link prediction problem by using node (e.g., a member profile) and edge (e.g., member connections) features in the social graph to predict whether an invitation will occur between two nodes that are not directly connected. Of course, other types of content items may be surfaced to a user of a content publishing system, such as a job posting, invitation to join a particular group, and the like.

As described above, example embodiments may use impression discounts in surfacing content items to a user. As used herein, an impression discount may be data or logic that affects the likelihood that a given content item will be selected over another content item based on the historical data relating to a frequency, count, recency, and the like of surfacing the content item to the user. For example, a content publisher may bias a selection method away from a content item (e.g., connection recommendation) if that content item was surfaced to a user a number of times in the recent past.

Accordingly, an example embodiment may relate to methods, systems, and machine readable medium for surfacing a selected content item based on an impression discount. For example, some embodiments may determine an impression discount for a content item. The impression discount may be determined based on a number of times the content item has been surfaced to a user. A selection score for the content item is then updated based on the impression discount. The content item is selected from a plurality of content items based on a comparison of the selection score for the content item and selection scores for each of the plurality of content items. The selected content item is then surfaced to a client device corresponding to the user.

Example embodiments may provide many practical applications. For example, some systems and methods may leverage impression discounts to lessen the likelihood that a content item is surfaced to a user if that content item has been repeatedly surfaced to the user without that user showing much interest in that content item. This may allow a content publishing system to select other content items to surface to the user even where the original content item appears to otherwise be relevant to the user.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

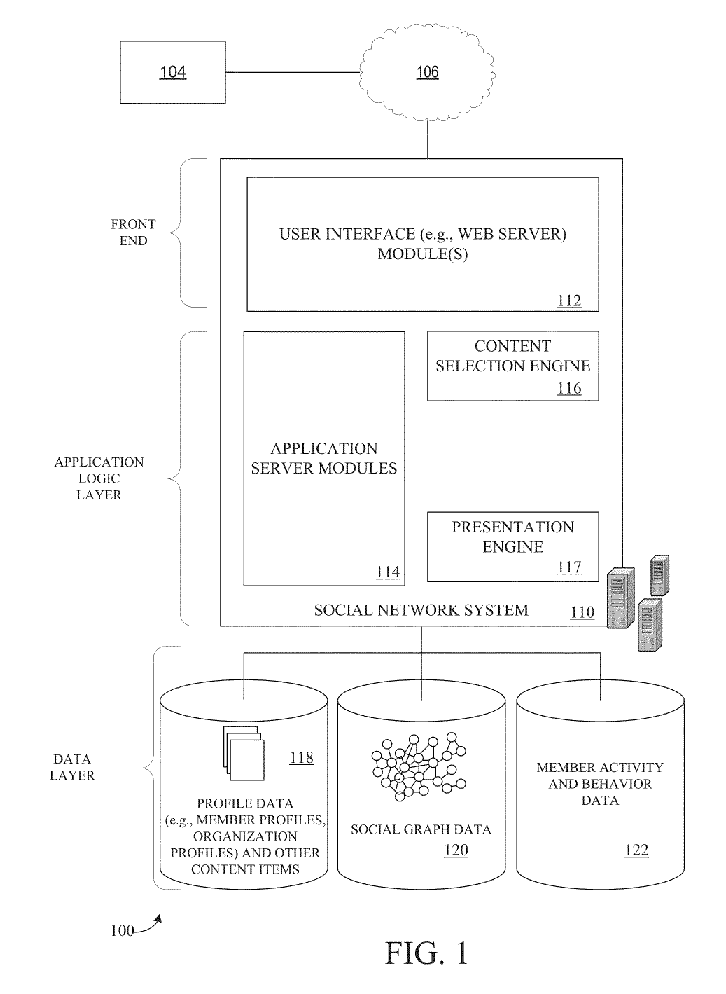

FIG. 1 is a block diagram illustrating various components or functional modules of a content publishing service 100, consistent with some embodiments, according to an example embodiment. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the content publishing service 100 to facilitate additional functionality that is not specifically described herein. Furthermore, the various functional modules and engines depicted in FIG. 1 may reside on a single server computer, or may be distributed across several server computers in various arrangements

As shown in FIG. 1, a front end layer of the content publisher system 110 includes a user interface module (e.g., a web server) 112, which receives requests from various client-computing devices, such as a client device 104, over a network 106, and communicates appropriate responses to the requesting client devices. For example, the user interface module(s) 112 may receive requests in the form of Hypertext Transport Protocol (HTTP) requests, or other web-based, application programming interface (API) requests. The client device 104 may be any suitable computing device—such as a personal computer, laptop, cellular phone, smart phone, computing tablet, and the like—executing conventional web browser applications, or applications that have been developed for a specific platform (e.g., operating system, computer system, or some combination thereof).

The network 106 may be any communications network utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, wireless data networks (e.g., Wi-Fi® and WiMax® networks), and so on.

The application logic layer of the content publisher system 110 includes various application server modules 114, which, in conjunction with the user interface module(s) 112, generates various user interfaces (e.g., web pages) with data retrieved from various data sources in the data layer. With some embodiments, individual application server modules 114 are used to implement the functionality associated with various services and features of the content publishing service 100. For instance, the ability to generate connection recommendations for a user may be a service (or services) implemented in independent application server modules 114. Similarly, a variety of other applications or services that are made available to users of the content publishing service 100 will be embodied in their own application server modules 114. For example, with some embodiments, the content publisher system 110 includes modules that may individually or in combination select between different content items and surface those selected content items to a user, such as a content selection engine 116 and a presentation engine 117.

The content selection engine 116 may be a computer-implemented module configured to select content items that are to be surfaced to a user of the content publisher service 100. Example embodiments of the content selection engine 116 may use a variety of information to select a content item from multiple content items, such as data derived representing a number of times a content item has been surfaced to a user, a frequency in which the content item has been surfaced to the user (as may be referred to as a visit frequency metric), and a recency in which the content item was last surfaced to the user.

The presentation engine 117 may be a computer-implemented module configured to generate user interface elements for interacting with the content items selected by the content selection engine 116. For instance, the presentation engine 117 may generate data and logic that, when executed on by one or more processors, causes a client device to display a user interface that depicts the member profile recommendation. In some cases, the presentation engine 117 may use the member profile recommendation to generate user interface elements that may cause the content publishing service 100 to create a member connection (or initiate the process for forming a member connection) between the source member profile and the member profile represented by the member profile recommendation.

As shown in FIG. 1, the data layer includes several databases, such as a database 118 for storing profile data and content items. Consistent with some embodiments, when a person initially registers to become a member of the content publishing service 100, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 118.

Once registered, a member may invite other members, or be invited by other members, to connect via the content publishing service. A “member connection, or simply “connection,” may require a bi-lateral agreement by the members, such that both members acknowledge the establishment of the connection. It is to be appreciated that members may “connect” with entities other than member profiles, such as companies, groups, or any other suitable cohort. The various associations and relationships that the members establish with other members, or with other entities represented by date stored in the database 118, are stored and maintained within the social graph, shown in FIG. 1 with reference number 120.

The content publishing service 100 may provide a broad range of other applications and services that allow members the opportunity to share and receive information, often customized to the interests of the member. For example, with some embodiments, the content publishing service may include a photo sharing application that allows members to upload and share photos with other members. With some embodiments, members may be able to self-organize into groups, or interest groups, organized around a subject matter or topic of interest. With some embodiments, the content publishing service 100 may host various job listings providing details of job openings with various organizations.

As members interact with the various applications, services and content made available via the content publishing service, the members' behavior (e.g., content (e.g., profiles) viewed, links selected, messages sent, etc.) may be monitored and information concerning the member's behavior may be stored, for example, as indicated in FIG. 1 by the database with reference number 122. One type of behavior data that may be stored in database 122 is member activity between a member having one member profile with another member having another member profile. As described above, examples of member activities include activities where one member: visits a profile page of a member, messages the member, saves the member in a contact list, introduces the member to another member profile.

In addition to storing user interactions, the content selection engine 116 may store in the database 122 historical data relating to the content items being surfaced to the users of the content publishing service 100. Such data, as is explained in greater detail below, may include a count of the number of times a content item has been surfaced to a given user, a frequency in which the content item has been surfaced to the given user, a recency of the last time the content item has been surfaced to the given user, and the like.

### Example Data Structures for Impression Discounting

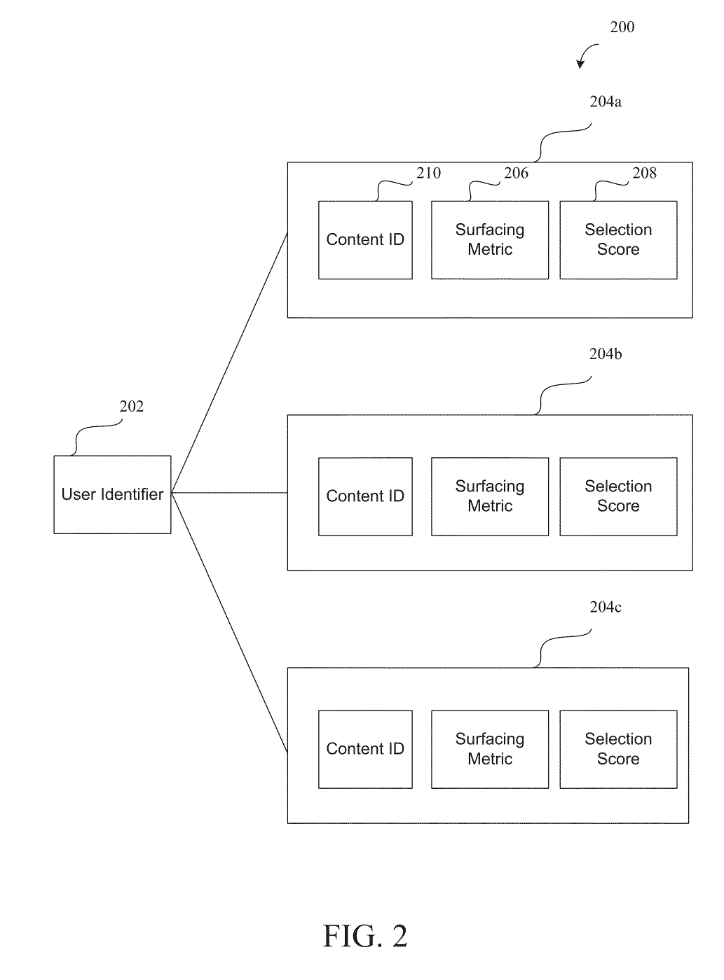

As discussed above, the content selection engine 116 may be configured to use impression discounts to select between content items to surface to a user. Accordingly, example embodiments of data structures used to generate impression discounts are now discussed in greater detail. FIG. 2 is a data diagram illustrating an example of a data structure 200 that includes a user identifier field 202 that corresponds or otherwise maps to one or more content item fields 204a-c, according to an example embodiment. The user identifier field 202 may be a unique identifier used to distinguish between two or more users of a system. In some cases, the user identifier field 202 may be a unique identifier that uniquely maps to a member profile of the social networking service 100.

Each of the content item fields 204a-c include data or logic capable of identifying a content item and data or logic for calculating a selection score and impression discount for that content item. For example, as shown in FIG. 2, the content item field 204a may include a content identification field 210, a surfacing metric field 206, and a selection score 208. The content identification field 210 may be data or logic that uniquely identifies a content item from the database 118. The surfacing metric field 206 may include one or more properties characterizing the a frequency and a recency, among other things, of the content item corresponding to the content identification field 210 being surfaced to the user corresponding to the user identifier 202. Such properties, may include, but are not necessarily limited to, a count in which the content item has been surfaced to the user, a frequency (e.g., a number of times over a time period) in which the content item has been surfaced to the user, a time period in which the content item was last surfaced to the user, and the like. In some cases, the surfacing metric field 206 may be periodically “refreshed,” such that surfacing metric field 206 includes data from a given time period (e.g., the last X minutes/days/weeks/or any other suitable time period).

In some example embodiments, the surfacing metric field 206 may be expressed as a single value, referred to as an impression discount. The impression discount may be measurement which affects the likelihood that a content item is to be surfaced to a user. In other embodiments, the data structure 200 may not directly store the impression discount for a given content item. Instead, the content selection engine 116 may process the surfacing metric field 206 to calculate the impression discount.

As FIG. 2 shows, the data structure 200 may further include additional fields, such as the selection field 208. The selection field 208 may include data or logic that characterizes the likelihood that the content item identified by the content identification field 210 is relevant to a user. In general, the selection field 208 may include data that measures how closely the subject matter of a given content item maps to the observed interests of the user. In embodiments that surface connection recommendations, for example, if the user has connections to members that would suggest that the user would be interested in connecting with a given member profile, the selection field 208 may include a selection score that biases the content selection engine 117 to select the given member profile.

Similar to the content item field 202a being specific to the user identified by the user identifier 202 and the content specified by the content identification field 210, each of the content item fields 202b and 202c are specific to the user and other content items. Thus, those content item fields, will include surfacing metrics specific to the user and a content item, and surfacing scores specific to the user and a content item.

It is to be appreciated that the data structure 200 shown in FIG. 2 is provided merely as an example for clarity of description and other embodiments consistent with this disclosure may utilize data structures having different formats or with different properties or fields.

### Example Methods of Generating Member Profile Recommendations

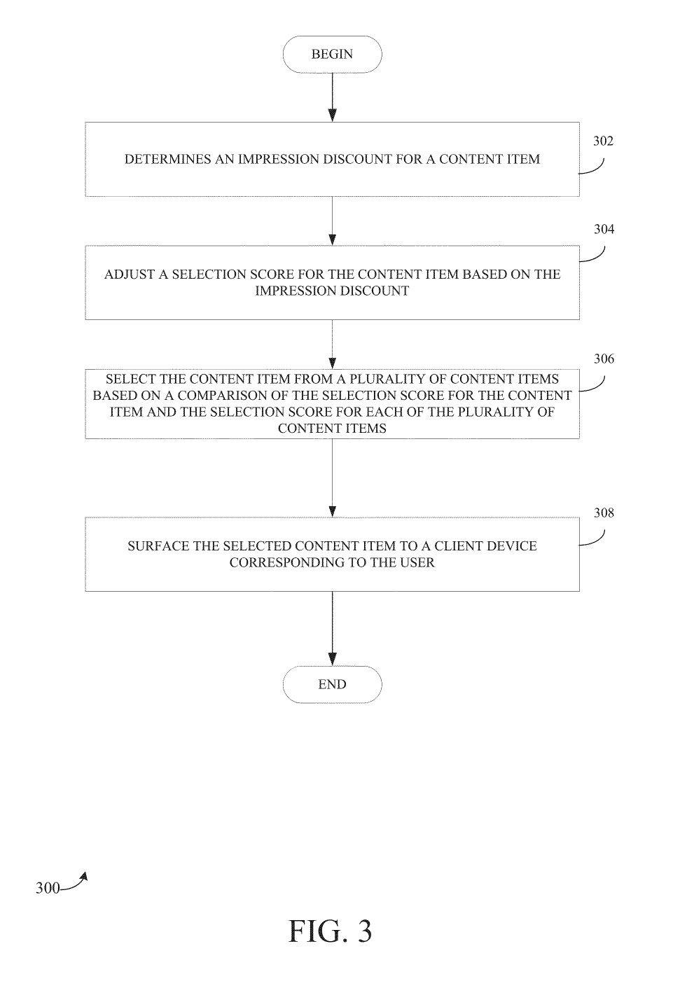

As described herein, the content selection engine 116 may perform various methods when surfacing selected content items using an impression discount. FIG. 3 is a flow diagram illustrating an example method 300 for selecting and surfacing content items based on an impression discount, consistent with some embodiments. The method 300 may be performed by the content selection engine 116 and presentation engine 117 and, accordingly, is described herein merely by way of reference thereto. However, it will be appreciated that the method 300 may be performed on any suitable hardware. The method 300 may also be performed by operating on the data structure 200 shown in FIG. 2 and, accordingly, is described herein merely by way of reference thereto. However, it will be appreciated that the method 300 may be performed on any suitable data structure.

The method 300 may begin at operation 302 when the content selection engine 116 determines an impression discount for a content item. In an example embodiment, the content selection engine 116 may determine or otherwise calculate the impression discount based on a number of times the content item has been surfaced in the past to a user.

At operation 304, the content selection engine 116 may then adjust a selection score for the content item based on the impression discount. The selection scores for the content item may bias the content selection engine 116 from selecting one content item over another content item.

It is to be appreciated that the operations 302 and 304 may be part of a periodic task executed by the content selection engine 116 to update the selection scores for one or more content items that may be surfaced to a user. Thus, operations 302 and 304 may be repeated any number of times for a number of content items that may be surfaced for a given user. Further, operations 302 and 304 may be repeated any number of times for a number of users to generate selections scores for content items for those users.

At operation 306, the content selection engine 116 may select the content item from a plurality of content items based on a comparison of the selection score for the content item and the selection score for each of the plurality of content items. For example, the content item may be selected over content items because the selection score corresponding to the content item is favored over the any or all of the selection scores corresponding to the plurality of content items.

At operation 308, the presentation engine 308 may then surface the selected content item to a client device corresponding to the user. Surfacing the selected content item may involve the presentation engine 308 communicating data representing the selected content item which may be configured to be displayable within a user interface element displayed on the client device. As part of surfacing the selected content item, the selection engine 116 may increment a count of the number of times the selected content item has been surfaced to the user. Such an update may involve the selection engine 116 updating the surfacing metric of a content item field with a content identification field matching the selected content item.

It is to be appreciated that the method 300 may be executed, all or in part, responsive to the content selection engine 116 detecting a surfacing event. A surfacing event may be an event that indicates that the content selection engine 116 is to surface a content item to a client device corresponding to the user. In some cases, the content selection engine 116 may detect the surfacing event through an explicit request through an application programmable interface (e.g., a function call or web-based service request) or based on detecting that the user logged into or otherwise accessed the social network. The surfacing event may include data that specifies a member profile belonging to the user (e.g., a member profile identifier that uniquely identifies the member profile from the other member profiles in the content publishing service) for the content item.

It is also to be appreciated that the method 300, all or in part, may be executed as a batch process that executes during scheduled downtimes, as suggested above. For example, in some embodiments, the content selection engine 116 may periodically perform operations 302 and 304 to generate or otherwise update selection tables for various member profiles. In turn, operations 306 and 308 may then be executed when, for example, the recommendation system detects that the user of the source member profile has accessed a site, web page, user interface configured display the selectable content items.

### Example User Interface

As described herein, the presentation engine 117 may surface content items selected by the content selection engine 116 to client devices operated by users of the content publishing service 100. In the case of connection recommendations, the content from a member profile may be presented in conjunction with actionable display elements that may, in some cases, cause the content publishing service 100 to create a direct member connection between the member profile of the user and the member profile represented by the connection recommendation surfaced by the presentation engine 117.

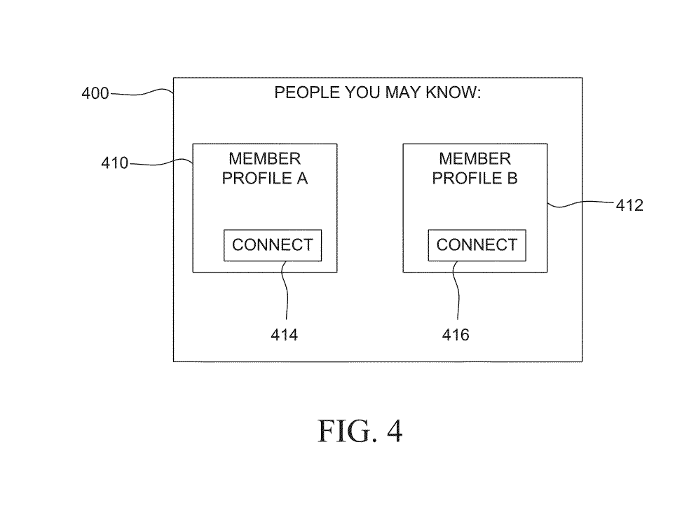

FIG. 4 is a user interface diagram illustrating a user interface 400 that the surfacing engine 117 may surface to a client device of a user, according to an example embodiment. By way of example and not limitation, the user interface 400 shown in FIG. 4 may surface content items such as member profile recommendations to the client device 104 of a content publishing service 100, although this disclosure contemplates that other embodiments may surface other types of content items to the client device.

FIG. 4 shows that the user interface 400 may include a suggestion module 440 that surfaces (e.g., displays) connection recommendations 410-412 that operate to suggest and form member connections between the user and the suggested member profile. For example, the connection recommendations 410-412 may be data or logic that may represent content derived from member profiles selected by the content selection engine 116. For clarity of description, not limitation, connection recommendation 410 may include content derived from one member profile (Member Profile A) of a social graph, and connection recommendation 412 may include content derived from another member profile (Member Profile B) of the social graph. In some cases, the content selection engine 116 may determine that the member profile represented by the member connections 410 and 412 are likely to be of interest to the user operating the client device 104 because the member profiles represented by the member connections 410 and 412 exhibit features or properties that are similar to the user. Such may be the case, for example, where the user, Member Profile A, and Member Profile B each list an employer in common in their profiles.

FIG. 4 shows that the connection recommendations 410 and 412 each include connection activators 414 and 416, respectively. A connection activator may be an actionable user interface element that causes, when activated by the source member, the content publishing service to send an invitation to the member profile corresponding to the connection recommendation. For example, responsive to the user activating the connection activator 414, the content publishing service 100 may then send an invitation to the corresponding member profile to form a member connection with the user and the corresponding member profile.

However, if the user does not select or otherwise activate one of the connection activators (e.g., connection activators 414 and 416) then the content publishing service 100 does not form a connection with the user and any of the member profiles. In this case, it may be apt to say that the connection recommendations 410 and 412 represent member profiles that are not of interest to the user.

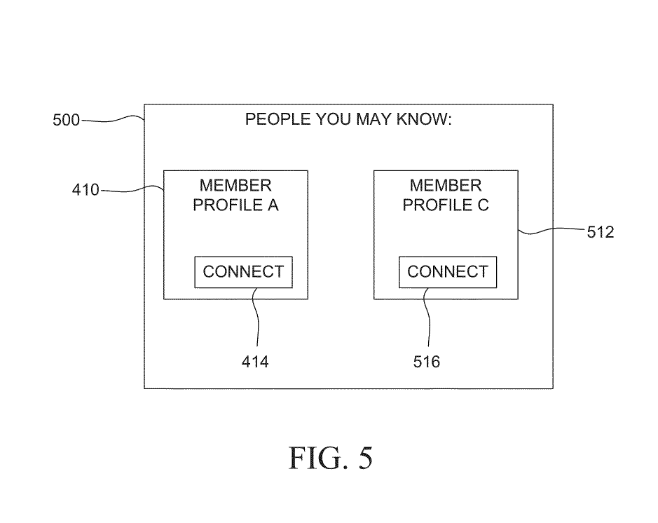

FIG. 5 is a user interface diagram illustrating another user interface 500 that the surfacing engine 117 may surface to a client device of a user, according to an example embodiment. By way of example and not limitation, the user interface 500 shown in FIG. 5 may surface content items such as member profile recommendations to the client device 104 at a later point in time, relative to the user interface 400 shown in FIG. 4. For example, the user interface 400 of FIG. 4 may be a user interface generated on a first day, while the user interface 500 of FIG. 5 may be a user interface generated on a later day.

Compared to the user interface 400 shown in FIG. 4, the user interface 500 includes a different connection recommendation, notably connection recommendation 512, that replaces connection recommendation 412. Such may be the case where the impression discount associated with the connection recommendation 412 results in the selection score for the connection recommendation 412 being lower than the selection score for connection recommendation 512. The user may form a member connection with Member Profile C by activating the connection activator 516.

Thus, rather than continually surfacing the same connection recommendations, embodiments may surface new content items to increase the likelihood that a relevant content item is eventually surfaced to the user.

It is to be appreciated that the user interfaces 400 and 500 shown in FIGS. 4 and 5 are provided to illustrate example embodiments and should not be interpreted as limiting any aspect of other example embodiments contemplated by this disclosure. For example, other embodiments may display more or less connection recommendations (e.g., three connection recommendations). Further, according to some embodiments, the member profiles represented by the connection recommendations may differ, depending on the implementation of the content selection engine 116 discussed above.

### Example Computer Systems

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

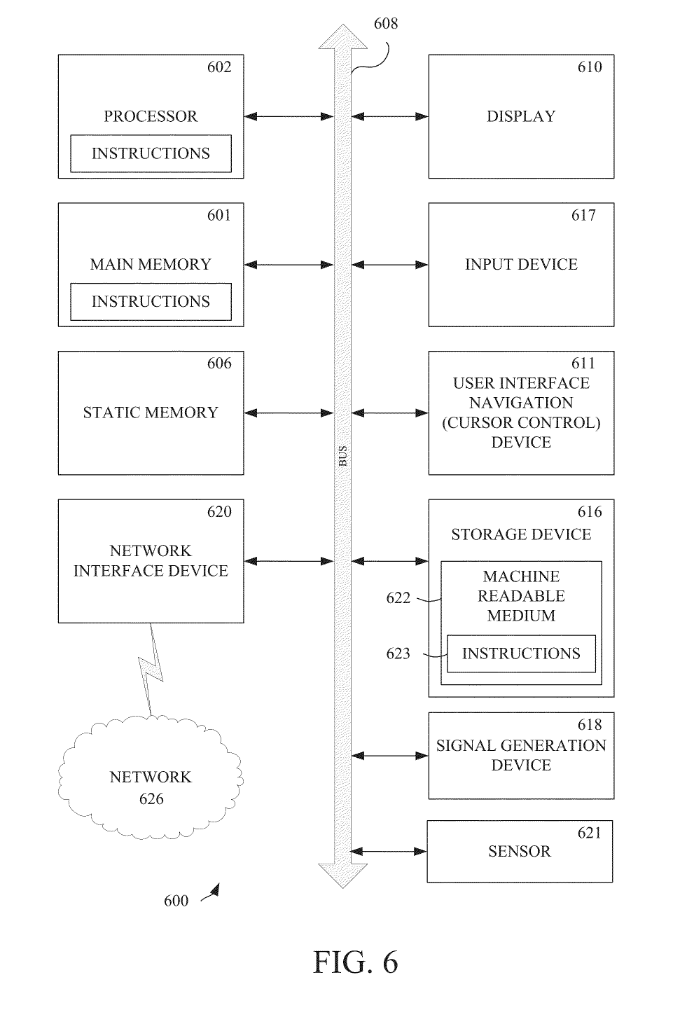

FIG. 6 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a display unit 610, an alphanumeric input device 612 (e.g., a keyboard), and a user interface (UI) navigation device 614 (e.g., a mouse). In one embodiment, the display, input device and cursor control device are a touch screen display. The computer system 600 may additionally include a storage device 616 (e.g., drive unit), a signal generation device 618 (e.g., a speaker), a network interface device 620, and one or more sensors, such as a global positioning system sensor, compass, accelerometer, or other sensor.

The drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 624 may further be transmitted or received over a communications network 626 using a transmission medium via the network interface device 620 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A computer-implemented method comprising:
determining a selection score based on an impression discount for a job posting, the impression discount being determined based on a number of times the job posting has been surfaced to a user and a visit frequency metric measuring a frequency in which the user accesses a content publisher that surfaces the job posting;
increasing the impression discount for the job posting based on an increase to the number of times the job posting has been surfaced to the user;
decreasing the selection score for the job posting based on the increased impression discount;
selecting the job posting from a plurality of job postings based on a comparison of the selection score for the job posting and selection scores for each of the plurality of job postings; and
surfacing the selected job posting to a client device corresponding to the user.

2. (canceled)

3. (canceled)

4. The computer-implemented method of claim 1, wherein the number of times the job posting has been surfaced to the user is within a time period.

5. The computer-implemented method of claim 1, wherein the impression discount is further determined based on a last seen metric, the last seen metric measuring a time period in which the job posting was last surfaced to the user.

6. (canceled)

7. The computer-implemented method of claim 1, further comprising:
incrementing the number of times the job posting has been surfaced to the user responsive to the surfacing of the job posting to the user;
updating the impression discount for the job posting, the impression discount being updated after incrementing the number of times the job posting has been surfaced to the user;
adjusting a selection score for the job posting based on the updated impression discount;
selecting one of the plurality of job postings over the job posting based on a comparison between a selection score for the one of the plurality of job postings and the adjusted selection score for the job posting; and
surfacing the one of the plurality of job postings to the client device corresponding to the user.

8. The computer-implemented method of claim 1, wherein the selection score for the job posting and the selection scores for each of the plurality of job postings form a first selection score group specific to the user.

9. The computer-implemented method of claim 1, further comprising:
determining an additional impression discount for the job posting, the additional impression discount being determined based on an additional number of times the job posting has been surfaced to an additional user;
adjusting an additional selection score for the job posting based on the additional impression discount;
selecting the job posting from the plurality of job postings based on a comparison of the additional selection score for the job posting and additional selection scores for each of the plurality of job postings; and
surfacing the job posting to an additional client device corresponding to the additional user.

10. The computer-implemented method of claim 9, wherein the additional selection score for the job posting and the additional selection scores for each of the plurality of job postings form a second selection score group specific to the additional user.

11. A computer-implemented system comprising:
a memory for storing executable instructions;
at least one processor for executing instructions stored in memory;
a content selection engine implemented by the least one processor and configured to:
determine a selection score based on an impression discount for a job posting, the impression discount being determined based on a number of times the job posting has been surfaced to a user,
increase the impression discount for the job posting based on an increase to the number of times the job posting has been surfaced to the user;
decrease the selection score for the job posting based on the increased impression discount, and
select the job posting from a plurality of content items based on a comparison of the selection score for the job posting and selection scores for each of the plurality of content items; and
a presentation engine implemented by the at least one processor and configured to surface the selected job posting to a client device corresponding to the user.

12. (canceled)

13. (canceled)

14. The computer-implemented system of claim 11, wherein the number of times the job posting has been surfaced to the user is within a time period.

15. The computer-implemented system of claim 11, wherein the impression discount is further determined based on a last seen metric, the last seen metric measuring a time period in which the job posting was last surfaced to the user.

16. The computer-implemented system of claim 11, wherein impression discount is further determined based on a visit frequency metric, the visit frequency metric measuring a frequency in which the user accesses a content publisher that surfaces the job posting.

17. The computer-implemented system of claim 11, wherein the content selection engine is further configured to:
increment the number of times the job posting has been surfaced to the user responsive to the surfacing of the job posting to the user;
update the impression discount for the job posting, the impression discount being after incrementing the number of times the job posting has been surfaced to a user;
adjust a selection score for the job posting based on the updated impression discount;
select one of the plurality of content items over the job posting based on a comparison between a selection score for the one of the plurality of content items and the adjusted selection score for the job posting; and
the presentation engine is further configured to surface the one of the plurality of content items to the client device corresponding to the user;

18. The computer-implemented system of claim 11, wherein the selection score for the job posting and the selection scores for each of the plurality of content items form a first selection score group specific to the user.

19. The computer-implemented system of claim 11, wherein:
the content selection engine is further configured to:
determine an additional impression discount for the job posting, the additional impression discount being determined based on an additional number of times the job posting has been surfaced to an additional user;
adjust an additional selection score for the job posting based on the additional impression discount;
select the job posting from the plurality of content items based on a comparison of the additional selection score for the job posting and additional selection scores for each of the plurality of content items; and
the presentation engine is further configured to surface the job posting to an additional client device corresponding to the additional user.

20. A non-transitory computer-readable medium storing executable instructions thereon, which, when executed by a processor, cause the processor to perform operations comprising:
determining a selection score based on an impression discount for a job posting, the impression discount being determined based on a number of times the job posting has been surfaced to a user;
increasing the impression discount for the job posting based on an increase to the number of times the job posting has been surfaced to the user;
decreasing the selection score for the job posting based on the increased impression discount;
selecting the job posting from a plurality of content items based on a comparison of the selection score for the job posting and selection score for each of the plurality of content items; and
surfacing the selected job posting to a client device corresponding to the user.
